(19) United States
(12) Patent Application Publication
(10) Pub. No.: US 2016/0354742 A1
(43) Pub. Date: Dec. 8, 2016

(54) SYSTEM AND METHOD FOR BLENDING BIOGAS

(71) Applicants: Stuart Russell, Wheaton, IL (US); Thomas Blair, Naperville, IL (US); James Buenzow, Broken Arrow, OK (US); Robert Adams, Batavia, IL (US)

(72) Inventors: Stuart Russell, Wheaton, IL (US); Thomas Blair, Naperville, IL (US); James Buenzow, Broken Arrow, OK (US); Robert Adams, Batavia, IL (US)

(21) Appl. No.: 15/242,577

(22) Filed: Aug. 21, 2016

Related U.S. Application Data
(62) Division of application No. 14/112,934, filed on Oct. 20, 2013.
(60) Provisional application No. 61/478,553, filed on Apr. 25, 2011.

(51) Int. Cl. B01F 15/00; G05D 11/13; F23K 5/00; B01F 15/02; C10L 3/10

(52) U.S. Cl. CPC B01F 15/00285; B01F 15/0203; B01F 15/0261; B01F 15/00305; B01F 15/00422; C10L 3/10; F23K 5/002; G05D 11/13; B01F 2215/0085; C10L 2290/58; C10L 2290/24; F23K 2401/10; F23K 2900/05004

(57) ABSTRACT

A method and system for blending biogas with conventional fuel in which the fuel blend is automatically adjusted for lower biogas flows and methane concentrations by introducing higher concentrations of conventional fuels. The system is able to automatically adjust the fuel blend, thereby eliminating the requirement for manual intervention, and producing a variable blended biogas that can be utilized within existing natural-gas fired combustion units such as boilers, furnaces, heaters, etc., as well as enabling automatic adjustment and operation, maximum usage of biogas, and integration with combustion unit controls. Using all available biogas to provide energy also minimizes the need for flaring unused biogas.

### CROSS REFERENCE TO RELATED APPLICATIONS

This application claims the benefit of the filing date of pending U.S. patent application Ser. No. 14/112,934, filed on Oct. 20, 2013, which claims the benefit of international patent application PCT/US11/51667 filed on Sep. 15, 2011, which claims priority of U.S. provisional patent application Ser. No. 61/478,553 filed on Apr. 25, 2011. The disclosures of all said applications are hereby incorporated by reference in their entirety.

### BACKGROUND

The present system relates generally to a blending method and device for gases and, more particularly, to a biogas blender for automatically adjusting biogas and conventional fuel mixtures to deliver an accurate biogas blend for use in existing natural gas-fired combustion units.

Currently available gas blending systems typically use a mixture of propane and air. Propane is a by-product of natural gas processing and petroleum refining. The air and propane are blended to match the Wobbe Index (WI) for natural gas. The WI is an indicator of the interchangeability of fuel gases such as natural gas, liquefied petroleum gas (LPG), and town gas. If two fuels have an identical WI, then for given pressure and flow settings the energy output will also be identical. It should be noted that different WI characteristics are used in different countries and different applications. Accordingly, machines are designed to maintain the appropriate WI value. Most existing combustion units are then tuned to a specific constant fuel or dual fuel, such as natural gas or biogas.

As society continues to deplete fossil fuel reserves, alternate energy solutions are constantly being sought to supplant fossil fuel sources such as propane and natural gas with cleaner and more abundant energy sources. In addition, there is also an attempt to go “green” by reducing environmental impact of waste and reducing carbon footprints.

Biogas is a relatively clean alternate energy source. Biogas is a waste gas that typically comes from a landfill, anaerobic digester, covered lagoon, ethanol plant, food processing plant or other similar source. Systems are available to burn biogas as a source of fuel for boilers, combined heat power (CHP) systems and other combustion systems. However, it is known that the usefulness of presently available biogas blending systems is limited by the inconsistent flow or quality of the biogas, and limitations of combustion units to only accept a constant WI fuel.

Typically, making use of the fuel value in biogas requires burning the biogas in a combustion unit in one of two ways. The first is to directly use the released heat, such as in HVAC systems, industrial furnaces or ovens. The second is to convert the released heat into another form of energy such as steam boilers, hot water boilers, or engines and gas turbines to generate electric power. Combustion units may either be new units specifically designed to utilize biogas as a fuel, or existing units that are typically designed to burn natural gas that are modified to burn biogas. The use of modified existing combustion units has a significant cost advantage over the use of new units because the capital costs for purchase and installation of the unit is much lower.

The fuel trains, which consist of a series of safety valves, metering and control valves required by codes and regulations for fuel gas combustion, and the burners that mix the fuel gas with air and provide ignition for combustion of the various combustion units, are typically designed to burn a fuel gas of a relatively constant composition. The composition is typically defined by calorific value per unit volume (e.g. Btu per cubic foot, or MJ per cubic meter), and gas specific gravity. The Wobbe Index (WI) is often used to define gas combustion characteristics, and is the calorific value of a gas corrected by its specific gravity according to a mathematical formula. Biogas typically has a different calorific value and WI than natural gas and other conventional fuel gasses. Therefore, in order to burn biogas, the fuel trains and burners of the combustion unit must be designed and set for biogas, and cannot be easily changed.

A major problem with the utilization of biogas is that the biogas flow and WI in many cases are variable. Therefore, when the flow and WI of the biogas fall outside of the range required by the combustion unit, the biogas combustion unit must be shut down. This problem is especially applicable to the use of a modified existing combustion unit that may have a maximum firing rate of a predetermined Btu per hour that may at times exceed the heat input provided by the available biogas. This situation requires the biogas to be flared, thereby wasting its fuel value. In addition, the combustion unit in this instance is out of service and an additional combustion unit burning conventional fuel must be in place to provide the energy lost due to the shutdown of the biogas combustion unit. The cost of a conventional fuel standby unit may offset the value of burning the biogas, discouraging the use of the biogas.

Current solutions to the above problems include the use of dual-fuel burners and fuel blending. In a dual-fuel solution, separate fuel trains and burners for biogas and a conventional fuel are installed in a single combustion unit. When the biogas flow or WI is out of the desired range, the biogas burner is switched off The conventional fuel burner is then switched on to keep the combustion unit operating. These dual-fuel units can either be new or modified existing units. In the blending solution, the biogas is mixed with a conventional fuel such as natural gas, LPG, etc. that is blended with air to create a blended gas with a consistent flow and WI that matches the requirements of the combustion unit. These gas blenders utilize a variety of mechanisms to blend a conventional fuel with air to simulate the WI of the biogas to augment the biogas flow.

Unfortunately, there are several disadvantages inherent to currently known dual-fuel and fuel-blending solutions. In a dual-fuel system, there is a high cost of buying or retrofitting a combustion unit with two separate fuel trains and burners and the need for an operator to switch between fuels. In addition, the biogas that is out of operating range must still be flared, wasting its fuel value. The disadvantage of the blending solution is that the combustion unit must still be purchased or modified to burn biogas with a constant WI, and cannot be used to burn a conventional fuel.

Another significant disadvantage with current systems is that when biogas is not available, such as during digester shut downs and maintenance of the biogas compressor or other components of the biogas system, the conventional fuel/air blending solution can supply a fuel/air blend at a WI equivalent to the biogas to keep the combustion unit operating. However, this results in the derating of the existing combustion unit from its designed maximum capacity due to the diluted nature of the conventional fuel/air mixture. The modified burner is typically able to supply only 40% to 60% of the maximum heat input required to operate the combustion unit at its rated maximum capacity. This derating is potentially problematic if the design maximum capacity of the combustion unit is needed to supply energy for an industrial process or other application.

### BRIEF DESCRIPTION OF THE DRAWINGS

An understanding of the present method and system can be gained from the various embodiments and elements that are shown in the following figures, in which like reference numerals are intended to refer to like elements.

FIG. 1 is a schematic overview of the biogas blender system in accordance with the present teachings

FIG. 2 is a perspective view of the biogas blender system in accordance with the present teachings.

FIG. 3 is a schematic view of the inlet/outlet subsystem of the biogas blender of FIG. 1.

FIG. 4 is a schematic view of an exemplary operational embodiment of the biogas blender system in accordance with the present teachings.

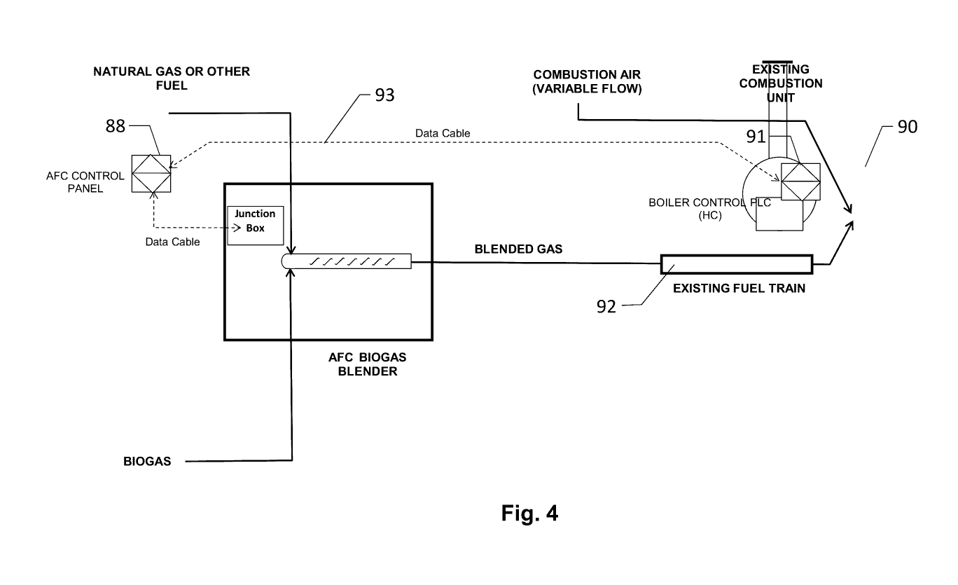

### DESCRIPTION

In order to provide a more efficient biogas fuel system and to overcome the disadvantages and problems of currently available fuel systems, a method and system for precisely blending biogas with conventional fuel gas to produce a usable variable WI value fuel for use in standard equipment is described herein. The system utilizes a gas blender that blends the biogas with a conventional fuel combined with a combustion unit burner control system that adjusts for a blended fuel with a variable WI. Thus, biogas may be burned even when its flow or WI varies substantially.

The biogas system is designed to preferentially burn biogas, and to augment the biogas with a conventional fuel when the available heat value of the biogas is insufficient to supply the boiler heat input demand. By blending a conventional fuel with the biogas, the WI of the blended gas changes. The blender communicates this WI change to the burner control system, which adjusts the burner for the changed combustion conditions.

Because the system is able to automatically adjust the fuel blend, the requirement for manual intervention is eliminated. In addition, by using all the available biogas to provide energy, the need for flaring and the waste of the biogas is also reduced or eliminated. The present system may also be used in CHP applications with an optional WI meter, to maintain consistent gas quality. Similarly, the system also may be used to supplement variable biogas flow to maintain continuous operation of systems.

Currently known conventional fuel/air mixing systems are typically designed to blend mixtures of air and fuel, such as propane or natural gas, and do not make use of all available biogas. As a result, in order to utilize biogas, many users of these systems must install both a biogas supply system and a conventional fuel/air mixing system, and then manually “switch” back and forth between the two based on biogas availability. In addition, some fuel mixing systems utilize a single piston valve at the confluence of the gases to blend the gases to a specific calorific value that is set based on the theoretical mixture of the gas. These pistons “stick” and are limited in their flow control because of their single dependent nature of the two sides of the valve. That is, the two streams cannot be controlled independently. For example, when one side of the valve opens the other side necessarily closes and vice versa.

The present biogas blending system described herein incorporates an active flow control (AFC) system that advantageously eliminates the expense and inconvenience of needing both a conventional fuel system and a biogas system by providing a single system for mixing both biogas and conventional fuel at a variable ratio to simulate the combustion characteristics of natural gas or any other fuel gas. In other words, the blended biogas can have the same combustion properties as biogas, natural gas, or any combination in between. Accordingly, the blended biogas may be used with existing equipment, may be mixed with natural gas and also may be used as emergency backup to natural gas. In addition, because the blending system automatically adjusts to compensate for changes in biogas quality, blended biogas may be used in virtually all natural gas applications. Therefore, a particular advantage of the present system is that the fuel train and burner of an existing combustion unit need not be modified substantially to accommodate the biogas, and that all of the available biogas can be utilized, even when its flow and WI are out of the expected range. A related advantage is the ability of the system to operate at its designed rated capacity using a conventional fuel even when there is no biogas available. In such instances, the present biogas blender supplies the combustion unit with 100% conventional fuel (not mixed with air), and the burner control system adjusts for this conventional fuel, allowing it to operate as it was originally designed at rated maximum capacity.

Another advantage of the present biogas blending system is its ability to deliver an accurate biogas blend instantaneously upon start-up and under rapid load changes. Fuel flow control valve(s) located at the biogas and/or fuel gas inlets modulate and maintain a consistent mixing between the biogas and conventional fuel streams, resulting in a variable blended biogas. The fuel flow control valves are independently adjustable by the use of a controller. The controller adjusts the valves in real time to the upstream and downstream conditions of the biogas production rate and the desired biogas gas blend.

Still another advantage of the biogas blending system is its capability of varying the blend characteristics. For example, the blender is configured to supply biogas as the primary fuel, blending in conventional fuel (natural gas, LPG or other) as necessary to provide adequate combustion in downstream units. Blending may also be adjusted for a constant fuel value with the use of an optional WI meter on the outlet of the blender. In addition, the system enjoys a relatively small footprint, is easy to install and operate, and allows the use of biogas at all times while minimizing the need for flaring. The system preferentially uses 100% of all biogas and adjusts the other fuel flow to match the requirements of the downstream combustion unit. In this manner, the system is completely customizable and flexible for the varying needs of the user.

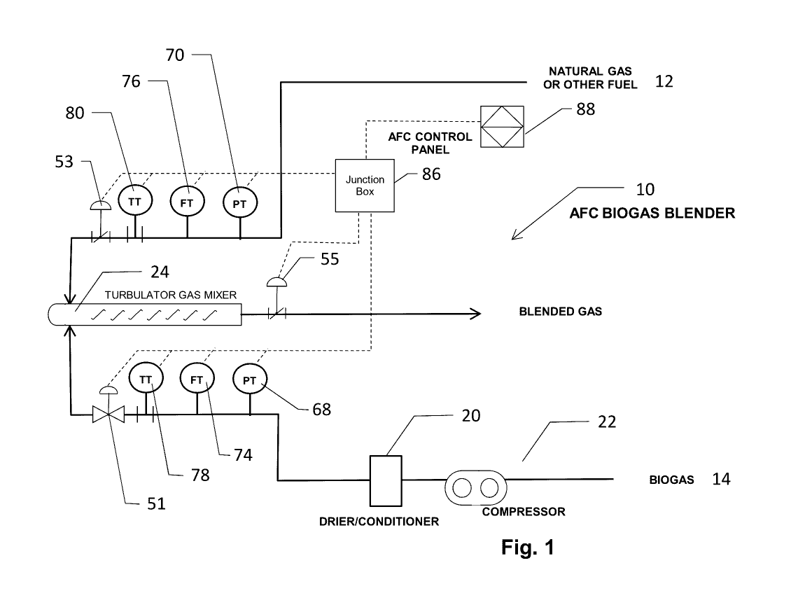

The schematic overview of FIG. 1 provides a high level conceptual diagram of an exemplary embodiment of the present biogas blending system. As shown, the system 10 includes two fuel sources, such as natural gas or LPG 12 and a relatively low BTU fuel such as biogas 14. The natural gas or LPG 12 is fed into the blender via a pressure regulator and monitored for temperature and pressure and flow. Similarly, the low BTU biogas 14 is input into a compressor 22, then fed into a dryer or conditioner 20 and then into the blender and monitored for pressure, temperature and flow.

Fuel flow control valves 51, 53, and 55 are used to regulate the amount of gas entering and exiting the system at their respective points. Each of the fuel control valves may be separate and independently controlled, enabling relatively fine adjustments as needed. In addition, the pressure meters 68, 70, the temperature meters 78, 80 and the flow meters 74, 76 enable close tracking of key operating parameters of the biogas blending system 10 so that adjustments can be made immediately by the control panel 88. Finally, the output from the blender is combined into a turbulator gas mixer 24 that actively blends the gasses and the outlet valve 55 controls the pressure and/or flow of the exiting blended gas. The output from the gas mixer 24 is then used to fire any kind of natural gas fired equipment such as boilers, furnaces, dryers, HVAC systems, reciprocating engines, etc.

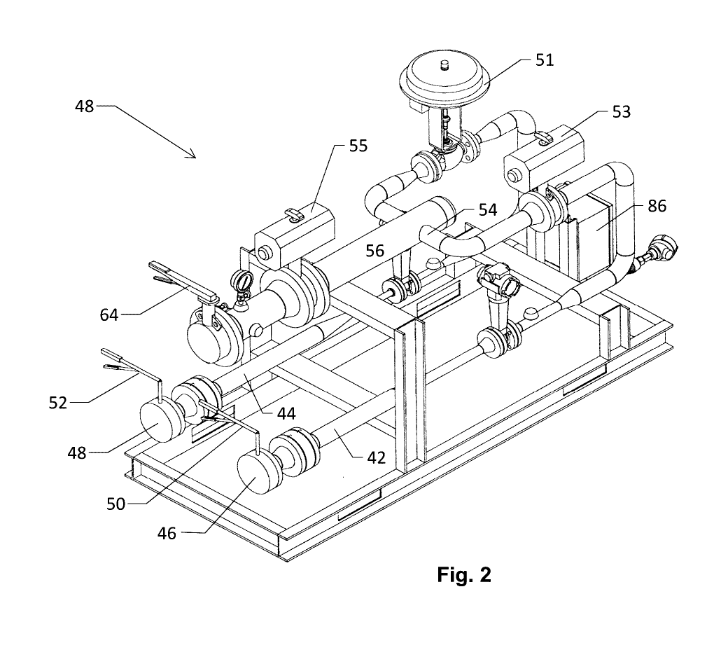

As shown in FIG. 2, the physical implementation of the biogas blender 48 is skid based for ease of fitting into existing or new installations. The blender 48 includes a fuel gas inlet line 42 and a biogas inlet line 44 in the form of metal or other tubing for receiving fuel gas in a first inlet 46 and biogas in a second inlet 48. Butterfly isolation valves 50, 52 are placed in-line with the inlet lines 42, 44. The fuel flow control valve 51, which is located in-line with the biogas inlet line 44, regulates biogas flow based on flow and control parameters.

The inlet lines 42, 44 feed into an entry point 54 of a mixing chamber 56. The mixing chamber 56 incorporates a turbulator (not shown) for actively mixing the gases. The mixed gas is then made available at the outlet 60 of the mixing chamber 56. The butterfly valve 64 located at the outlet of the mixing chamber 56 controls the amount of blended gas exiting the system. This provides the capability of creating an infinite number of fuel gas blends. For safety, a fuel gas automatic safety valve 53 and discharge automatic safety valve 55 are located in-line with the fuel gas inlet 42 and the mixed gas outlet 60, respectively.

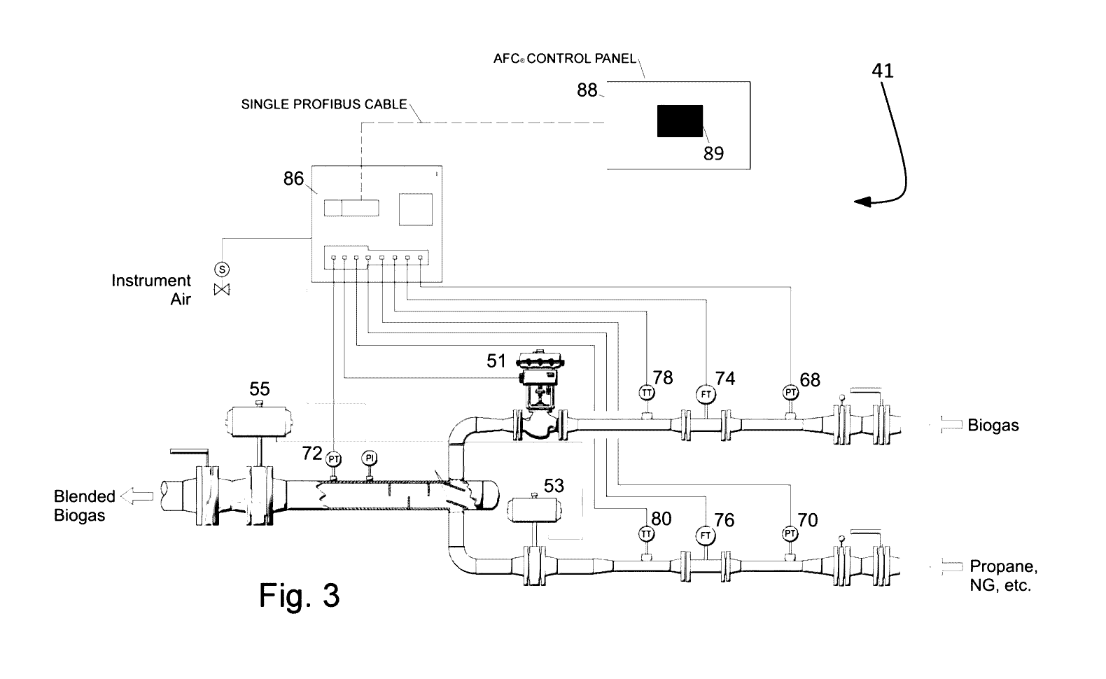

Turning to FIG. 3, the mixing subsystem 41 of the biogas blender 40 is shown in greater detail. Downstream from each of the inlets 46, 48, there are provided along the inlet lines 42, 44 several devices for monitoring critical operating parameters of the biogas blender 40. In particular, pressure transmitters 68, 70, 72, flow meters 74, 76 and temperature sensors 78, 80 ensure that the proper WI value of the blended gas is communicated through a system of feedback and feed forward mechanisms, as described further below.

Data output from the pressure transmitters 68, 70, flow meters 74, 76 and temperature sensors 78, 80 are consolidated at local junction box 86. The consolidated data is transmitted via data connection, such as a single Profibus cable or wirelessly, to the control panel 88. Advantageously, the control panel 88 utilizes a combined “feed-forward” and “feedback” control strategy. Simultaneously, actual flow through the biogas blender is compared with the calculated theoretical flow required to provide a fine-tuned optimum blend of biogas and fuel blend.

The control panel 88 controls the biogas blender to mix biogas and conventional fuel gas at a specific ratio to simulate the combustion characteristics of natural gas or other desired gas blends. The pressure transmitters 68, 70 and temperature compensated flow meters 74, 76 measure the regulated flow of biogas and fuel. The volumetric flow of both gas streams are converted to their true molar values taking into account the system process conditions. The ratio of the flow rates is then converted into the WI of the blended gas. Adjustments to the ratio are made and are performed by the fuel flow control valve 51. As the demand for blended gas either increases or decreases, the fuel flow control valve 51 modulates and maintains a blend between the biogas and conventional fuel streams. This results in a calculated WI value that can be used by downstream controllers to modulate fuel/air ratios within the downstream combustion units based on a variable WI, or to pinpoint a consistent WI so that downstream combustion units can operate on a constant fuel. Manual or automatic adjustments of the blending parameters are performed from a touch screen of an HMI (Human Machine Interface) 89 of the control panel 88.

The control panel 88 performs fine tuning immediately to adjust the blend to the proper proportions with minimal delay for use in rapid load change conditions. This eliminates the need for operator intervention or time consuming change-over between fuel trains. In addition, the control panel 88 is configured to deliver an accurate biogas blend instantaneously upon start-up. When the control panel 88 is started, the flow meters 74, 76 send a value to the control system 88, which pre-determines the position of the flow control valve 51 relative to the biogas flow rate.

The control panel 88 is configured with several important features to enable intelligent data processing and control. In particular, IEC61158-2 digital fieldbus communication is to prevent analog scaling errors or drift. All data is transmitted directly to the control panel 88 via digital fieldbus in 32-bit floating-point format. In addition, process values are transmitted with a diagnostic byte to indicate signal quality. If signal quality drops below a certain threshold level, an alarm is triggered. Several communications interfaces are available for communication between the junction box 86 and the control panel 88, such as RS-232, RS-485 or Ethernet. The communications interface may be configured to enable remote monitoring of the biogas blending system and its operation.

An additional feature of the control panel 88 is its ability to automatically calculate a WI of the blended gas, based on the influent biogas flow rate and other fuel gas flow parameters; or determine a fixed mixing ratio set-point to achieve the target WI and to automatically adjust the gas ratio accordingly. Another feature of the current blender is its ability for each flow stream to display real-time pressure, temperature, actual flow, corrected flow at standard conditions, molar flow, biogas stream velocity, compressibility factor, biogas density, volumetric ratio, molar ratio and real-time WI of the blended gas. This allows for integral real-time communication with a downstream controller.

Referring to FIGS. 2 and 3, an exemplary operational embodiment of the biogas blender system with an existing combustion unit 90 is illustrated. By way of example only, the shown combustion unit is referred to as a boiler. A boiler burner controller, such as a Honeywell HC900® Hybrid Control system (HC) 91, monitors key boiler instrumentation and a flame guard relay (FGR) (not shown), receives data from the AFC control panel 88 and adjusts the fuel air ratio based on required firing rate. Typically, a single HC is installed for each combustion unit. The HC controller 91, coupled with the control panel from the blender skid 88, and feed forward controls, allow an infinitely variable blend of biogas and fuel gas to be utilized in existing combustion equipment, utilizing the existing fuel train 92, instead of conventional “dual fuel stream” units, where the fuel must be either all fuel gas or all biogas.

A boiler flame management system (not shown), such as available from Cleaver Brooks, is used to monitor and confirm that burner safeties are met, as well as to provide pilot and main flame ignition. The HC 91 monitors multiple points from this safety relay to insure the boiler is operating safely.

The biogas blender communicates with the boiler or other combustion unit through a data cable 93 and communication network, such as a MODBUS RTU. The biogas blender is configured as the Modbus Master and the HC 91 operates as a Modbus slave. Information shared between the boiler and the biogas blender includes boiler fuel gas flow and mix ratio or WI. The boiler operating condition is read by the biogas blender for indicating the current fuel gas flow rate the boiler is using at any time. Additional information includes boiler “call for heat”. This on/off condition is read by the biogas blender. This status point indicates the boiler's demand for additional heating based on steam usage.

The “call for heat” signal is the initial indication that the boiler is initiating a start sequence to fire the burner. A boiler “main burner on” signal is read by the biogas blender. This status point indicates the boiler's two main gas valves are open and the main burner is operating. The combination of this status point and the call for heat status initializes the biogas blender to start.

During operation after the biogas blender has started, a fuel selected biogas signal is read by the biogas blender. This status condition indicates that the operator has selected biogas through the HC 91. When this status condition is set, the biogas blender delivers only biogas to the boiler. In those operating conditions, where full biogas is not available, the “blended biogas fuel selected” signal is read by the biogas blender. This status condition indicates that the operator has selected a mixture of biogas and fuel gas. When this status is set, the biogas blender controls the fuel gas mixture to the boiler and optimizes the use of the biogas as it is available. The composition of the blended gas is written as a data value from the biogas blender AFC control panel 88 to the HC 91. This information is used by the boiler control system to predict the type of fuel to be delivered to the burner (feed forward control). As noted above, this value is used by the burner controls to adjust the fuel/air ratio. A “Biogas Available” signal is also sent from the biogas blender to the HC 91 to indicate that biogas is available and that the biogas blender will deliver blended gas or 100% biogas depending on the boiler fuel selection status and the volume of biogas available.

In operation, when the biogas flow is off or nil, natural gas or other fuel gas is still allowed to flow through the conventional fuel side of the blender.

In automatic mode, the conventional fuel gas/biogas mixture is set by comparing the available biogas flow from the biogas compressor to the boiler's fuel gas flow rate. From this comparison, the blender defines the biogas percentage set point. As changes in the boiler fuel gas flow rate and biogas availability occur, the blended biogas percentage is adjusted to maximize biogas usage. Adjustments of the biogas percentage set-point are coordinated with the boiler combustion control system to maintain good combustion control while utilizing all available biogas.

The biogas blender, when used with optional boiler controls, is coordinated with the boiler operation. The biogas blender reads several signals from the boilers and starts when certain predefined conditions are met. In particular, when the “Call for Heat” signal is on, the “Main Gas Valve Closed” signal is off and the “Biogas Fuel Selected” signal is on, the biogas blender will start operation. The blender start-up biogas percentage set-point is defined by the blender's mode of operation.

When started in automatic control mode, the defined biogas percentage is adjusted as described above. If the blender is shut down due to combustion unit shut down or maintenance, for instance, the defined biogas percentage is retained for the next blender start. While shutdown, if the amount of biogas available is less than amount necessary to meet the retained biogas percentage set-point at the boiler's low fire position, the set-point is decreased. If the amount of biogas available is greater than the amount necessary to meet the retained biogas percentage set-point at the boiler's low fire position, the set-point remains unchanged and is increased after the boiler is operating at low fire.

What is claimed is:

1. A fuel blender for a combustion unit, comprising:
a first inlet for receiving biogas;
a second inlet for receiving fuel gas;
a chamber for receiving and mixing the biogas and the fuel gas;
a fuel control valve at each inlet for adjusting the relative amounts of the biogas and fuel gas entering the fuel chamber;
an outlet extending from the fuel chamber wherein the mixed fuels exit the fuel blender for providing fuel to a remote combustion unit.

2. The fuel blender of claim 1, further comprising:
a controller located at the combustion unit location for adjusting one or more of the control valves on the combustion unit for enabling the variable biogas blend to be utilized by the combustion unit.

3. The fuel blender of claim 2, wherein the controller includes a dynamic feedback system having real-time instruments for enabling the two-way communication between the blender and the combustion unit.

4. The fuel blender of claim 3, wherein the Wobbe Index values measured at the blender controller enable the combustion unit controls to adjust automatically to the variable biogas blend on a feed-forward basis.

5. The fuel blender of claim 4, wherein the Wobbe Index value is a calculated real-time value.

6. The fuel blender of claim 1, wherein the biogas is used as the primary source of fuel.
